(19) United States
(12) Patent Application Publication
(10) Pub. No.: US 2025/0371746 A1
(43) Pub. Date: Dec. 4, 2025

(54) COMPUTER ALERT NOTIFICATION WITH REAL-TIME IMAGE GENERATION

(71) Applicant: INTERNATIONAL BUSINESS MACHINES CORPORATION, ARMONK, NY (US)

(72) Inventors: Adam Dyszy, Wodzislaw Slaski (PL); Marta Anna Bereta, Bolechowice (PL); Jan Olszowka, Tychy (PL); Jakub Jan Solecki, Krakow (PL)

(21) Appl. No.: 18/676,914

(22) Filed: May 29, 2024

(51) Int. Cl. G06T 11/00; G06F 40/30

(52) U.S. Cl. CPC G06T 11/00; G06F 40/30

(57) ABSTRACT

A computer-implemented method for automatically generating, in real-time, an image notification corresponding to a computer alert. The method may include, based on receiving the computer alert on a computing device, automatically determining a computer component corresponding to the received computer alert, and automatically identifying a sentiment associated with the received computer alert. The method may also include, based on the determined computer component and the identified sentiment associated with the received computer alert, automatically generating the image notification corresponding to the received computer alert, wherein automatically generating the image notification further comprises automatically generating an image in real-time representing the determined computer component, and converting and incorporating the identified sentiment as an image feature in the generated image.

### BACKGROUND

The present invention relates generally to the field of computing, and more specifically, to automatically generating text-to-image computer notifications based on a computer alert.

Generally, a computer alert and notification system may include a combination of hardware and software components that may provide a notification to a user and may show activity that may relate to an account, application, system, and other computer components. For example, a notification may include a message that appears as text on a computer device, such as text describing when a computer network will be down for a scheduled maintenance. Thus, the notifications may include a brief text description regarding a hardware and/or software component that may provide current information such as updates, vulnerabilities, exploits, security issues, and other information.

### SUMMARY

A computer-implemented method for automatically generating, in real-time, an image notification corresponding to a computer alert is provided. The method may include, based on receiving the computer alert on a computing device, automatically determining a computer component corresponding to the received computer alert, and automatically identifying a sentiment associated with the received computer alert. The method may also include, based on the determined computer component and the identified sentiment associated with the received computer alert, automatically generating the image notification corresponding to the received computer alert, wherein automatically generating the image notification further comprises automatically generating an image in real-time representing the determined computer component, and converting and incorporating the identified sentiment as an image feature in the generated image.

A computer system for automatically generating, in real-time, an image notification corresponding to a computer alert is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing operational steps. The operational steps may include, based on receiving the computer alert on a computing device, automatically determining a computer component corresponding to the received computer alert, and automatically identifying a sentiment associated with the received computer alert. The operational steps may also include, based on the determined computer component and the identified sentiment associated with the received computer alert, automatically generating the image notification corresponding to the received computer alert, wherein automatically generating the image notification further comprises automatically generating an image in real-time representing the determined computer component, and converting and incorporating the identified sentiment as an image feature in the generated image.

A computer program product for automatically generating, in real-time, an image notification corresponding to a computer alert is provided. The computer program product may include one or more computer-readable storage devices and program instructions stored on at least one of the one or more tangible storage devices, the program instructions executable by a processor. The computer program product may include program instructions to, for a client in the collaborative multi-client federated learning system comprising a plurality of clients, automatically generate a local data ontology based on client data associated with the client, and automatically generating synthetic data based on the client data and the local data ontology. The computer program product may also include program instructions to, based on receiving the computer alert on a computing device, automatically determine a computer component corresponding to the received computer alert, and automatically identifying a sentiment associated with the received computer alert. The computer program product may further include program instructions to, based on the determined computer component and the identified sentiment associated with the received computer alert, automatically generating the image notification corresponding to the received computer alert, wherein automatically generating the image notification further comprises automatically generating an image in real-time representing the determined computer component, and converting and incorporating the identified sentiment as an image feature in the generated image.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to one embodiment;

FIG. 2 is an operational flowchart for a program for automatically generating, in real-time, an image notification corresponding to a computer alert according to one embodiment;

FIG. 3 is a diagram illustrating a configuration setting and system components of an image notification generation program for automatically generating, in real-time, an image notification corresponding to a computer alert according to one embodiment;

FIG. 4 illustrates images automatically generated, in real-time, by an image notification for automatically generating, in real-time, an image notification corresponding to a computer alert according to one embodiment;

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to automatically generating, in real-time, an image notification corresponding to a computer alert. Specifically, the present invention may improve the technical field associated with computer alert and notification systems by cognitively (i.e. using machine learning) generating a real-time image based on a computer alert associated with a computer component, whereby the generating further includes converting and incorporating an identified sentiment associated with the computer alert into the real-time generated image which may distinguish different computer alerts that may be associated with a computer component (and/or one or more different components) more distinctively.

Specifically, and as previously described, a computer alert and notification system may include a combination of hardware and software components that may provide a notification to a user device that shows activity relating to an account, application, system, and/or other computer component. More specifically, for example, the notifications may often include a brief text description regarding the computer component and may provide current information associated with the computer component. However, such notifications that include a brief text description for a computer component can often be repetitive in language and, consequently, each notification may be indistinguishable from each other, which in turn may cause a user to believe that the user has already seen or addressed a notification at a previous time. For example, conventionally, multiple notifications may be received in connection with a computing error and each notification may describe the computing error using a same brief text description. Additionally, each notification associated with the computer component may include a same general image that represents or corresponds to the computer component (such as an envelope image always representing a text message application) and, therefore, the general image fails to distinguish each notification associated with a computer component and also fails to give any indication of content within the notification.

As such, it may be advantageous, among other things, to provide a method, computer system, and computer program product for automatically generating, in real-time, an image notification corresponding to a computer alert. Specifically, the method, computer system, and computer program product may include, based on receiving the computer alert on a computing device, automatically determining a computer component corresponding to the received computer alert, and automatically identifying a sentiment associated with the received computer alert. The method, computer system, and computer program product may also include, based on the determined computer component and the identified sentiment associated with the received computer alert, automatically generating the image notification corresponding to the received computer alert, wherein automatically generating the image notification further includes automatically generating an image in real-time representing the determined computer component, and converting and incorporating the identified sentiment as an image feature in the generated image.

The present invention may be a computer system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer program product and computer readable storage medium, as those terms are used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine whether directional input is received along with a query and, accordingly, adjust presented display content to include a referenced object in a center of a screen of a primary device.

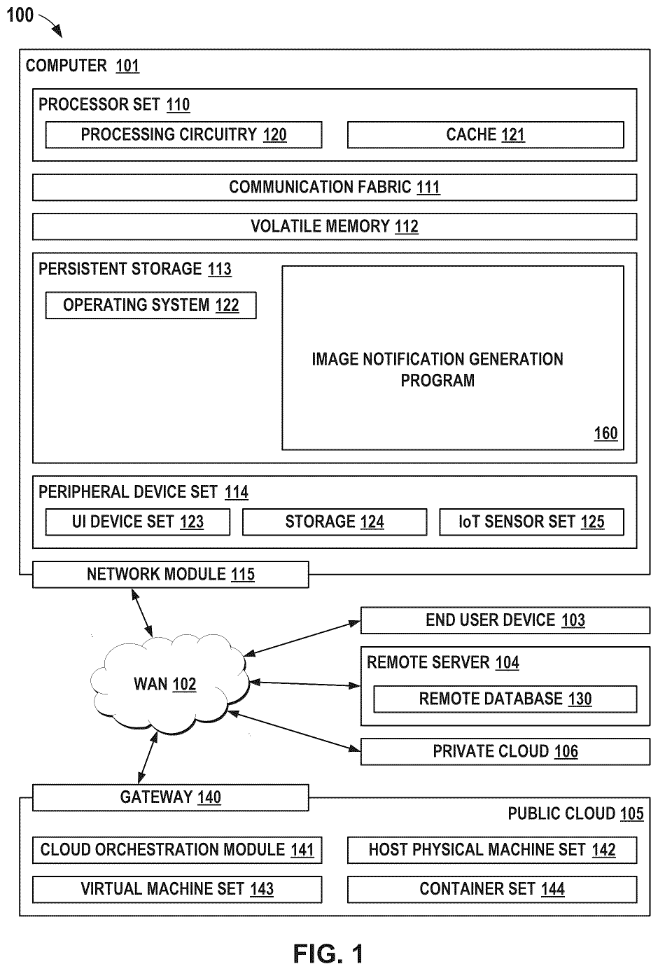

Referring to FIG. 1, an exemplary computing environment 100 is depicted, according to at least one embodiment. Computing environment 100 contains an example of an environment for the execution of at least some of the computer code involved in performing the inventive methods, such as an image notification generation program 160. In addition to block 160, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 160, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer (such as a wearable headset), mainframe computer, quantum computer or any other form of computer or mobile device now known or to be developed in the future that is capable of running a program, accessing a network and/or querying a database, such as database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 160 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 160 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles, headsets, and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector and/or accelerometer.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

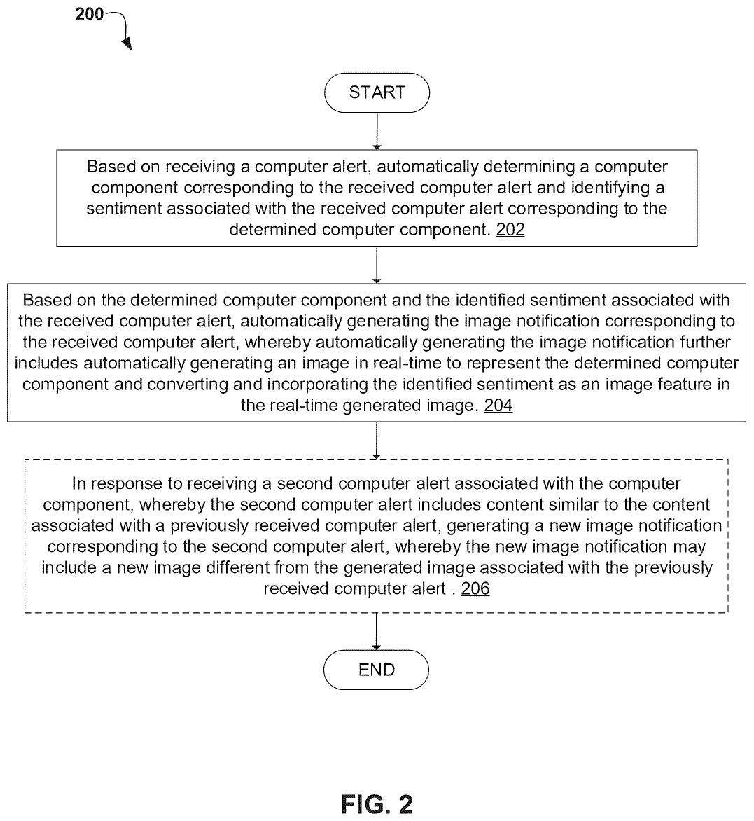

Furthermore, notwithstanding depiction in computer 101, the image notification generation program 160 may be stored in and/or executed by, individually or in any combination, with end user device 103, remote server 104, public cloud 105, and private cloud 106. The image notification generation program is explained in further detail below with respect to FIGS. 2-4.

According to the present embodiment, and as previously described, the image notification generation program 160 may be a program/code capable of automatically generating, in real-time, an image notification corresponding to a computer alert. Specifically, the image notification generation program 160 may, based on receiving the computer alert on a computing device, automatically determine a computer component corresponding to the received computer alert, and automatically identify a sentiment associated with the received computer alert. The image notification generation program 160 may also, based on the determined computer component and the identified sentiment associated with the received computer alert, automatically generate the image notification corresponding to the received computer alert, wherein automatically generating the image notification further includes automatically generating an image in real-time representing the determined computer component, and converting and incorporating the identified sentiment as an image feature in the generated image.

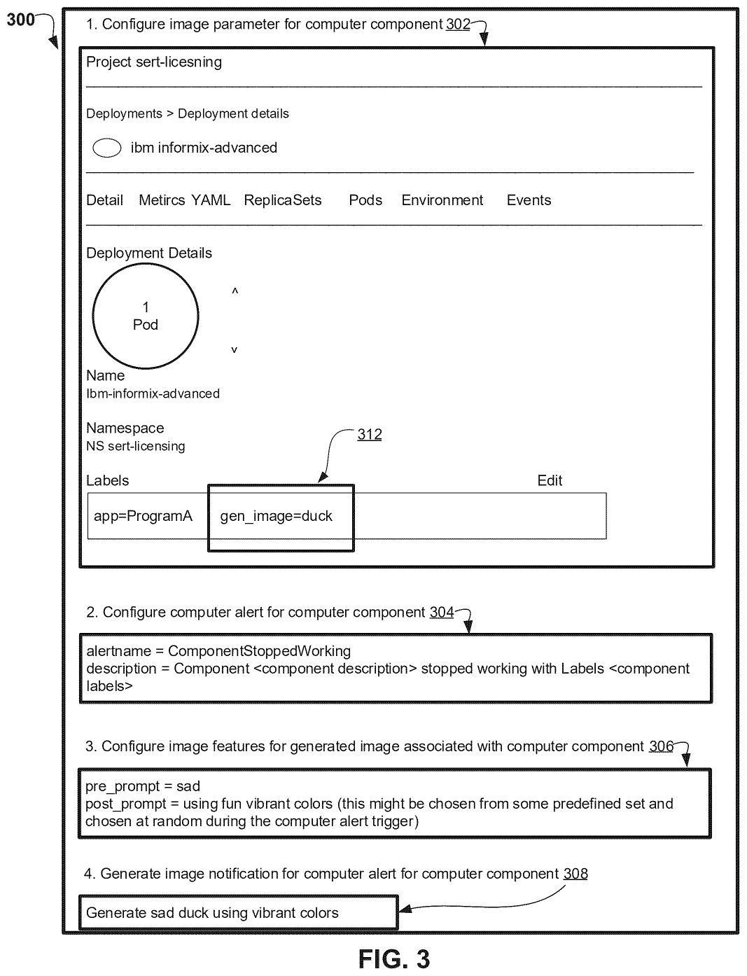

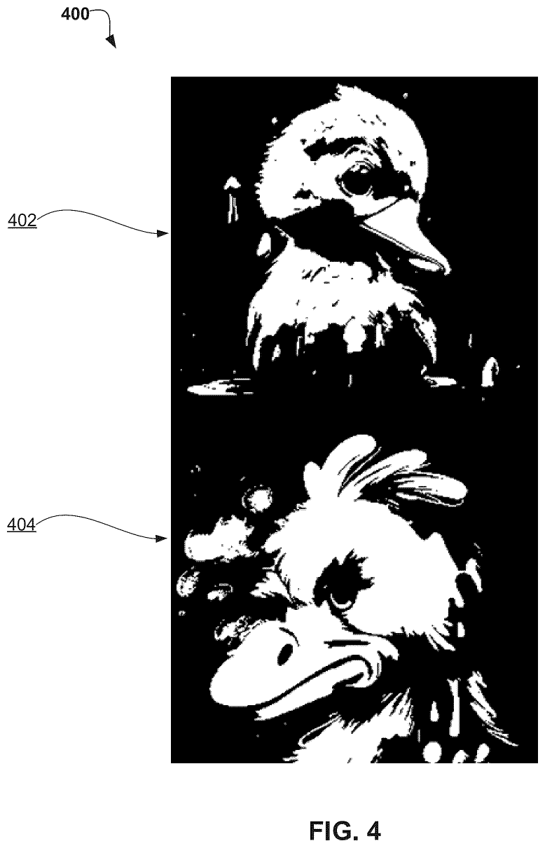

Referring to FIG. 2, an operational flowchart 200 for a program, such as the image notification generation program 160, for automatically generating, in real-time, an image notification corresponding to a computer alert is depicted. The operational flowchart 200 will also be described with references to FIGS. 3 and 4. According to embodiments, the image notification generation 160 may include, be associated with, and/or be an extension of a computer's alert and notification system that provides notifications to a computer and/or computing device associated with one or more computer components. According to one embodiment, a computer component may include software and hardware component such as, but not limited to, a computer account, computer program, computer application, and/or computer system hardware component. Accordingly, and as depicted at 202 in FIG. 2, the image notification generation program 160 may receive a computer alert associated with a computer component, and based on the received computer alert, may automatically determine a computer component corresponding to the received computer alert as well as identify a sentiment associated with the received computer alert that corresponds to the determined computer component. For example, the computer alert may include text specifically describing or indicating a computer component such as an operating system or program, and the text may further include a message describing activity related to the computer component (such as describing a computer error or issue).

Accordingly, based on receiving the computer alert, the image notification generation program 160 may determine a computer component corresponding to the received computer alert as well as identify a sentiment associated with the received computer alert by automatically analyzing the text associated with the computer alert. Specifically, the image notification generation program 160 may include and use machine learning (ML) and natural language processing (NLP) algorithms to analyze the text. More specifically, the ML and NLP algorithms may include algorithms that perform sentiment analysis, named entity recognition, summarization, topic modeling, text classification, keyword extraction, as well as lemmatization and stemming to analyze the text for structure, content, and meaning. Thus, as previously described at 202 in FIG. 2, in response to receiving the computer alert, and based on analysis of the text associated with the computer alert using the ML and NLP algorithms, the image notification generation program 160 may automatically determine a computer component corresponding to the received computer alert and identify a sentiment associated with the received computer alert that corresponds to the determined computer component.

For example, the computer alert may include text describing a specific program, such as “Program A,” and may further include text describing an issue with the program, such as “stopped working.” Accordingly, based on the analysis of the text associated with the computer alert, the image notification generation program 160 may determine that the computer component is “Program A” and that the program has “stopped working.” The image notification generation program 160 may further use the ML and NLP algorithms to identify and associate a sentiment with the text in the computer alert. Specifically, according to one embodiment, the image notification generation program 160 may be trained and/or configured to associate certain identified text and/or phrases within a computer alert with a certain sentiment. Generally, sentiment analysis in ML and NLP involves a process of analyzing text to determine an emotional tone of a message to determine, among other things, whether a message is positive, negative, or neutral Thus, according to one embodiment, the image notification generation program 160 may associate a sentiment with text in a computer alert to express the emotional tone which may include a “sad,” “happy”, “angry,” etc., tone for the computer alert. For example, the ML and NLP algorithms associated with the image notification generation program 160 may be trained to associate a “sad” sentiment with a computer alert that includes text and/or phrases such as “error,” “not responding,” or “stopped working.” Therefore, according to one embodiment, the ML and NLP algorithms associated with the image notification generation program 160 may be trained to automatically detect and associate different sentiments with different text and/or combinations of text, whereby the ML and NLP algorithms may be trained using one or more ML and NLP training processes (including known methods for training a ML model). Alternatively, or in addition, the image notification generation program 160 may be directly configured (for example, via a user interface) to associate the text and/or phrases within a computer alert with a sentiment.

Next, at 204, the image notification generation program 160 may, based on the determined computer component and the identified sentiment associated with the received computer alert, automatically generate the image notification corresponding to the received computer alert, whereby automatically generating the image notification further includes automatically generating an image in real-time to represent the determined computer component and converting and incorporating the identified sentiment as an image feature in the real-time generated image. As previously described at step 202, the image notification generation program 160 may include and use ML and NLP algorithms to analyze text. The image notification generation program 160 may further be configured as well as include/use ML algorithms to generate an image corresponding to the computer alert. An example configuration setting and system components 300 for generating an image notification associated with a computer alert for a computer component is depicted in FIG. 3. Specifically, FIG. 3 depicts an example of the image notification generation program 160 as part of an extension of Kubernetes® (Kubernetes and all Kubernetes-based trademarks and logos are trademarks or registered trademarks of the Linux Foundation and/or its affiliates) whereby a user interface may be used to configure generation of an image notification for a computer alert associated with a computer component. As depicted at 302, the image notification generation program 160 may identify and associate an image parameter with a computer component, such as “Program A,” so that an image that corresponds to the image parameter may be generated to represent the computer component. For example, in a “Labels” section 312 of FIG. 3, “app-ProgramA” (i.e. “Program A”) may be configured with an image parameter of a duck via the configuration setting “gen_image-duck”. Thus, the image notification generation program 160 may be configured such that, for “app-ProgramA” (i.e. “Program A”), the image notification generation program 160 shall generate (using ML algorithms such as image generator algorithms) a real-time image of a duck which may be used to represent a notification sent from “Program A.”

In addition to automatically generating a real-time image representing the determined computer component, the image notification generation program 160 may also convert and incorporate the identified sentiment as an image feature in the generated real-time image. As previously described at step 202 in FIG. 2, the ML and NLP algorithms associated with the image notification generation program 160 may be trained to automatically detect and associate different sentiments with different text and/or combinations of text and, in turn, the ML and NLP algorithms may automatically convert and incorporate the identified sentiment as an image feature in the real-time generated image. Alternatively, or in addition, the image notification generation program 160 may be configured (for example, via a user interface) to associate the text and/or phrases within a computer alert with a sentiment, and the ML and NLP algorithms may automatically convert and incorporate the identified sentiment as an image feature in the real-time generated image. An example configuration setting for configuring an alert for a computer component and associating a sentiment with certain text identified in the computer alert is depicted in steps 304 and 306, respectively, of FIG. 3. For example, at 304, a computer alert may be configured for a computer component (which may include “Program A”), whereby a description of the computer alert includes text such as “stopped working.” Then, according to one embodiment, the ML and NLP algorithms associated with the image notification generation program 160 may be trained to automatically detect and associate different sentiments with different text and/or combinations of text identified in a computer alert, and/or as depicted at 306, the image notification generation program 160 may be configured to associate the text and/or phrases within the computer alert with a sentiment. For example, at 306, the image notification generation program 160 may be configured to associate the text, “stopped working,” with a “sad” sentiment as represented in a “pre_prompt” configuration setting. As further depicted at 306 in FIG. 3, additional image features may also be configured, such as configuration setting to generate an image with vibrant colors as shown in a “post_prompt” configuration setting.

In turn, and as depicted at 308 in FIG. 3 (and previously described at 204 in FIG. 2), the image notification generation program 160 may, based on the determined computer component and the identified sentiment associated with the received computer alert, automatically generate the image notification corresponding to the received computer alert. For example, and previously described, the computer alert may include text describing a specific program, such as “Program A,” and further includes text describing an issue with the program, such as “stopped working.” Accordingly, based on the analysis of the text associated with the computer alert, the image notification generation program 160 may determine that the computer component is “Program A” and that the program has “stopped working.” Therefore, based on an example configuration setting (as depicted at 302 in FIG. 3), the image notification generation program 160 may determine to generate, in real-time, an image of a duck to represent identification of the computer component (i.e, “Program A”) that is sending the computer alert. The image notification generation program 160 may further use the ML and NLP algorithms to identify and associate a sentiment with the text in the computer alert. Specifically, the ML and NLP algorithms associated with the image notification generation program 160 may be trained to automatically detect and associate different sentiments with different text and/or combinations of text identified in a computer alert, and/or as depicted at 306, the image notification generation program 160 may be configured to associate the text and/or phrases within the computer alert with a sentiment. Thus, for example, the image notification generation program 160 may associate the text, “stopped working,” with a “sad” sentiment. Accordingly, and as depicted at 402 in illustrated example images 400 of FIG. 4, based on the determined computer component and the identified sentiment associated with the received computer alert for “Program A”, the image notification generation program 160 may use the ML algorithms to automatically generate an image, such as a sad duck, that corresponds to the received computer alert. Thereafter, the image notification generation program 160 may automatically present the image that includes the sad duck as an image notification in response to receiving the computer alert. According to one embodiment, in addition to presenting the image notification with the generated real-time image, the image notification generation program 160 may also present the image notification with the generated real-time image and the text from the computer alert that describes the computer component and the alert.

Then, at 206, in response to receiving a second computer alert associated with the computer component, whereby the second computer alert may include content (such as text) similar to the content/text associated with a previously received computer alert (such as the computer alert described at step 202), the image notification generation program 160 may automatically generate (in real-time) a new image notification corresponding to the second computer alert, whereby the new image notification may include a new image different from the generated image associated with the previously received computer alert (and/or a different version of the generated image described at 204). As previously noted with conventional practices, multiple notifications may be received in connection with a computing error and each notification may describe the computing error using a same brief text description. Additionally, in conventional practice, each notification associated with the computer component may include a same general image that represents or corresponds to the computer component (such as a same envelope image always representing a text message application) and, therefore, the general image fails to distinguish each notification associated with a computer component and also fails to give any indication of content within the notification. Therefore, the image notification generation program 160 addresses such as an issue with real-time image notification generation by automatically generating a different and/or new version of the image notification to correspond to the second computer alert associated with the computer component, whereby the second computer alert may include text similar to the text associated with a previously received computer alert.

For example, the second computer alert may similarly include text describing a program, such as “Program A,” and further includes text describing an issue with the program, such as “stopped working.” Accordingly, based on the analysis of the text associated with the second computer alert, the image notification generation program 160 may determine that the computer component is “Program A” and that the program has “stopped working.” Therefore, based on an example configuration setting (as depicted at 302 in FIG. 3), the image notification generation program 160 may determine to generate, in real-time, an image of a duck to represent identification of the computer component (i.e, “Program A”) that is sending the computer alert. The image notification generation program 160 may further use the ML and NLP algorithms to identify and associate a sentiment with the text in the computer alert. Specifically, and as previously described, the ML and NLP algorithms associated with the image notification generation program 160 may be trained to automatically detect and associate different sentiments with different text and/or combinations of text identified in the second computer alert, and/or as depicted at 306, the image notification generation program 160 may be configured to associate the text and/or phrases within the second computer alert with a sentiment. Thus, for example, the image notification generation program 160 may associate the text, “stopped working,” with a “sad” sentiment. Accordingly, and as depicted at 402 in FIG. 4, based on the determined computer component and the identified sentiment associated with the received second computer alert for “Program A”, the image notification generation program 160 may use the ML algorithms to automatically generate a new image of a sad duck that corresponds to the received second computer alert. Specifically, the image notification generation program 160 may also use ML algorithms to further detect a previously generated image that is associated with a previous computer alert (such as the computer alert described at step 202) that includes similar text/content. Accordingly, and as depicted at 404 in the illustrated example images 400 of FIG. 4, the image notification generation program 160 may use the ML algorithms to automatically generate a different and/or new image of the sad duck to correspond to the received second computer alert. For example, the new image may include a different “sad” expression on a duck or a more intense “sad” expression on the duck to represent a level of frustration associated with repeated “stopped working” notifications. Thereafter, the image notification generation program 160 may automatically present the new image, which may include a different and/or new version of the sad duck, as an image notification in response to receiving the second computer alert. As such, by generating different images for a computer component (and/or different versions of an image), the image notification generation program 160 may distinguish each notification associated with the computer component while simultaneously giving an indication of content within the notification.

It may be appreciated that FIGS. 2-4 provide only illustrations of one implementation and does not imply any limitations with regard to how different embodiments may be implemented. Many modifications to the depicted environments may be made based on design and implementation requirements. For example, the image notification generation program 160 may also use the ML and NLP algorithms to automatically determine an image parameter based on the text and/or type of alert associated with the computer alert. Specifically, and as previously described at step 304, the image notification generation program 160 may associate an image parameter with a computer component, such as “Program A,” so that an image that corresponds to the image parameter may be generated to represent the computer component. As depicted, the image parameter is represented as a configuration setting in the “Labels” section 312 of FIG. 3, whereby “app-ProgramA” (i.e. “Program A”) may be configured with an image parameter of a duck via the configuration setting “gen_image=duck”. Thus, the image notification generation program 160 may be configured such that, for “app-ProgramA” (i.e. “Program A”), the image notification generation program 160 shall generate a real-time image of a duck which may be used to represent a notification sent from “Program A.”

However, according to one embodiment, the image notification generation program 160 may also use the ML and NLP algorithms to automatically determine the image parameter based on the text and/or type of alert associated with the computer alert, and then generate a ream-time image based on the automatically determined image parameter. For example, a typical computer alert in Kubernetes® may include a CrashLoopBackOff error, whereby CrashLoopBackOff is a common error that occurs when a container fails to start up properly and repeatedly crashes. Accordingly, the image notification generation program 160 may determine that the type of computer alert is a CrashLoopBackOff error, and based on the ML and NLP algorithms, may detect that CrashLoopBackOff indicates a container failing to start up properly and repeatedly crashing. Accordingly, applying the ML and NLP algorithms to the type of alert and/or text included in the computer alert, the image notification generation program 160 may determine an image parameter of a loop and generate an image of open loop (such as a loop with a link missing in the loop) to represent a container that is repeatedly crashing.

Furthermore, in addition to automatically identifying and associating a sentiment with text in the received computer alert as described at step 202, the image notification generation program 160 may further identify and incorporate an identified level of the computer alert in the associated sentiment (and/or the image feature representing the identified sentiment in the generated image). Specifically, for example, regarding a “sad” sentiment, not all computer alerts associated with a “sad” sentiment may be deemed equal. For example, a computer alert that may simply include text such as “stopped working” may be less “sad” than a computer alert that includes text such as “catastrophic error”. As such, the image notification generation program 160 may also use the ML and NLP algorithms to detect and incorporate a level of the computer alert in the image feature based on the text included in the computer alert, whereby incorporating the level may include increasing an intensity of an expression associated with the image feature. As previously described, the image notification generation program 160 may also detect repeated computer alerts, and may in turn, increase an intensity of the image feature associated with the “sad” sentiment to incorporate and represent a level of frustration associated with having repeated computer alerts of a same issue.

As previously described, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Furthermore, machine learning as described herein may broadly refer to machine learning algorithms that learn from data. More specifically, machine learning is a branch of artificial intelligence that relates to algorithms such as mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusters, such as k-means clusters, mean-shift clusters, and spectral clusters; (v) factorization machines, principal component analyzers and kernel principal component analyzers; and (vi) ensembles or other combinations of machine-learning models. Neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

What is claimed is:

1. A computer-implemented method for automatically generating, in real-time, an image notification corresponding to a computer alert, the computer-implemented method comprising:
based on receiving the computer alert on a computing device, automatically determining a computer component corresponding to the received computer alert, and automatically identifying a sentiment associated with the received computer alert; and
based on the determined computer component and the identified sentiment associated with the received computer alert, automatically generating the image notification corresponding to the received computer alert, wherein automatically generating the image notification further comprises automatically generating an image in real-time representing the determined computer component, and converting and incorporating the identified sentiment as an image feature in the generated image.

2. The computer-implemented method of claim 1, further comprising:
automatically presenting the generated image notification on the computing device.

3. The computer-implemented method of claim 1, wherein automatically determining the computer component corresponding to the received computer alert and automatically identifying the sentiment associated with the received computer alert is further performed using machine learning (ML) algorithms and natural language processing (NLP) algorithms.

4. The computer-implemented method of claim 3, wherein automatically identifying the sentiment associated with the received computer alert further comprises:
training the ML algorithms and the NLP algorithms to identify and associate different sentiments with different text detected in different computer alerts, wherein the different sentiments comprise different emotional tones associated with the different text; and
applying the trained ML algorithms and the trained NLP algorithms to the received computer alert to automatically identify the sentiment among the different sentiments, and wherein automatically identifying the sentiment further comprises identifying an emotional tone of the received computer alert.

5. The computer-implemented method of claim 1, wherein automatically generating the image in real-time further comprises:
identifying and associating an image parameter with the determined computer component; and
automatically generating the image in real-time for the computer component based on the image parameter.

6. The computer-implemented method of claim 1, further comprising:
based on receiving a second computer alert associated with the determined computer component, wherein the second computer alert comprises content similar to the received computer alert, automatically generating in real-time a new image notification corresponding to the second computer alert, wherein automatically generating the new image notification further comprises automatically generating a new image different from the generated image associated with the received computer alert.

7. The computer-implemented method of claim 6, wherein the received computer alert and the second computer alert are each presented with text describing the determined computer component and activity associated with the determined computer component.

8. A computer system for automatically generating, in real-time, an image notification corresponding to a computer alert, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing operational steps comprising:
based on receiving the computer alert on a computing device, automatically determining a computer component corresponding to the received computer alert, and automatically identifying a sentiment associated with the received computer alert; and
based on the determined computer component and the identified sentiment associated with the received computer alert, automatically generating the image notification corresponding to the received computer alert, wherein automatically generating the image notification further comprises automatically generating an image in real-time representing the determined computer component, and converting and incorporating the identified sentiment as an image feature in the generated image.

9. The computer system of claim 8, further comprising:
automatically presenting the generated image notification on the computing device.

10. The computer system of claim 9, wherein automatically determining the computer component corresponding to the received computer alert and automatically identifying the sentiment associated with the received computer alert is further performed using machine learning (ML) algorithms and natural language processing (NLP) algorithms.

11. The computer system of claim 10, wherein automatically identifying the sentiment associated with the received computer alert further comprises:
training the ML algorithms and the NLP algorithms to identify and associate different sentiments with different text detected in different computer alerts, wherein the different sentiments comprise different emotional tones associated with the different text; and
applying the trained ML algorithms and the trained NLP algorithms to the received computer alert to automatically identify the sentiment among the different sentiments, and wherein automatically identifying the sentiment further comprises identifying an emotional tone of the received computer alert.

12. The computer system of claim 8, wherein automatically generating the image in real-time further comprises:
identifying and associating an image parameter with the determined computer component; and
automatically generating the image in real-time for the computer component based on the image parameter.

13. The computer system of claim 8, further comprising:
based on receiving a second computer alert associated with the determined computer component, wherein the second computer alert comprises content similar to the received computer alert, automatically generating in real-time a new image notification corresponding to the second computer alert, wherein automatically generating the new image notification further comprises automatically generating a new image different from the generated image associated with the received computer alert.

14. The computer system of claim 13, wherein the received computer alert and the second computer alert are each presented with text describing the determined computer component and activity associated with the determined computer component.

15. A computer program product for automatically generating, in real-time, an image notification corresponding to a computer alert, comprising:
one or more tangible computer-readable storage devices and program instructions stored on at least one of the one or more tangible computer-readable storage devices, the program instructions executable by a processor, the program instructions comprising:
based on receiving the computer alert on a computing device, automatically determining a computer component corresponding to the received computer alert, and automatically identifying a sentiment associated with the received computer alert; and
based on the determined computer component and the identified sentiment associated with the received computer alert, automatically generating the image notification corresponding to the received computer alert, wherein automatically generating the image notification further comprises automatically generating an image in real-time representing the determined computer component, and converting and incorporating the identified sentiment as an image feature in the generated image.

16. The computer program product of claim 15, wherein automatically determining the computer component corresponding to the received computer alert and automatically identifying the sentiment associated with the received computer alert is further performed using machine learning (ML) algorithms and natural language processing (NLP) algorithms.

17. The computer program product of claim 16, wherein automatically identifying the sentiment associated with the received computer alert further comprises:
training the ML algorithms and the NLP algorithms to identify and associate different sentiments with different text detected in different computer alerts, wherein the different sentiments comprise different emotional tones associated with the different text; and
applying the trained ML algorithms and the trained NLP algorithms to the received computer alert to automatically identify the sentiment among the different sentiments, and wherein automatically identifying the sentiment further comprises identifying an emotional tone of the received computer alert.

18. The computer program product of claim 15, wherein automatically generating the image in real-time further comprises:
identifying and associating an image parameter with the determined computer component; and
automatically generating the image in real-time for the computer component based on the image parameter.

19. The computer program product of claim 15, further comprising:
based on receiving a second computer alert associated with the determined computer component, wherein the second computer alert comprises content similar to the received computer alert, automatically generating in real-time a new image notification corresponding to the second computer alert, wherein automatically generating the new image notification further comprises automatically generating a new image different from the generated image associated with the received computer alert.

20. The computer program product of claim 19, wherein the received computer alert and the second computer alert are each presented with text describing the determined computer component and activity associated with the determined computer component.
